(19) United States
(12) Patent Application Publication
(10) Pub. No.: US 2002/0198956 A1
(43) Pub. Date: Dec. 26, 2002

(54) Method and apparatus for managing a cache

(75) Inventors: Andrew Dunshea, Austin, TX (US); James Newman Chen, Austin, TX (US); Madhu Chetuparambil, Pittsburgh, PA (US); Jeffry Paul Kaminski, Pittsburgh, PA (US)

Correspondence Address: Gregory W. Carr, Carr & Storm, L.L.P., 670 Founders Square, 900 Jackson Street, Dallas, TX, 75202, US

(73) Assignee: International Business Machines Corporation, Armonk, NY

(21) Appl. No.: 09/888,468

(22) Filed: Jun. 25, 2001

(51) Int. Cl. G06F 15/16; G06F 15/167

(52) U.S. Cl. 709/214; 709/203; 709/216

(57) ABSTRACT

The present invention comprises a method and an apparatus for managing the caching of a response. The caching of a response is managed by including in the response an indication of whether the response is to be cached, partially cached, or invalidated.

### BACKGROUND OF THE INVENTION

1. Field of the Invention

The invention relates generally to a method of providing access to information via a network and, more particularly, to a method of caching information to allow efficient access via the network.

2. Description of the Related Art

Information and data retrieval systems, commonly referred to as content hosts, are commonplace and are used in a wide variety of applications, particularly web-based applications. Web-based applications typically provide information and services to customers via a network, such as the Internet or an intranet, and allow users to request information, which is retrieved from the content host and provided to the user. As information and services provided by a content host become increasingly popular, however, the content host may be required to retrieve the same data multiple times. The retrieval of the information from the content host is generally a time-consuming action and may cause bottlenecks and other system degradation problems.

In an attempt to reduce the overhead associated with retrieving information from the content host, applications generally implement a caching scheme. The caching scheme typically saves information and data retrieved from the content host in the local memory, i.e., cache, of a server, commonly referred to as a cache proxy. Cache proxies generally require additional logic either to invalidate the cached data after a predetermined amount of time or to verify with the content host that the cached data is accurate.

Neither method, however, is ideal. Invalidating cached data after a predetermined amount of time may cause the invalidation of valid data, causing a needless request of the content host for a new copy of the data. Furthermore, requesting verification of the data validity with the content host is time-consuming and may cause additional bottlenecks and delays at the content host.

Therefore, there is a need for a method and an apparatus for efficiently invalidating the data stored in a cache when the data becomes inaccurate.

### SUMMARY OF THE INVENTION

The present invention comprises a method and an apparatus for managing the caching of URL information contained in a response by identifying a cache manager for each URL provided by a content host. The content host is then able to include in a response to a request for a URL an indication of whether the response is to be cached, not cached, or invalidated.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a diagram of a network environment that embodies features of the present invention;

FIG. 2 is a flow chart illustrating one embodiment of the present invention in which data is retrieved from the content host;

FIG. 3 is a flow chart illustrating one embodiment of the present invention in which a content host processes a retrieve request; and

FIG. 4 is a flow chart illustrating one embodiment of the present invention in which a content host processes an update request.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning telecommunications systems, the Internet, service provider network configurations, and the like, have been omitted inasmuch as such details are not considered necessary to obtain a complete understanding of the present invention, and are considered to be within the skills of persons of ordinary skill in the relevant art.

It is noted that Request For Comments (RFC) documents referenced herein are available from the Internet Engineering Task Force (IETF), including the IETF Internet web page located at http://www.ietf.org.

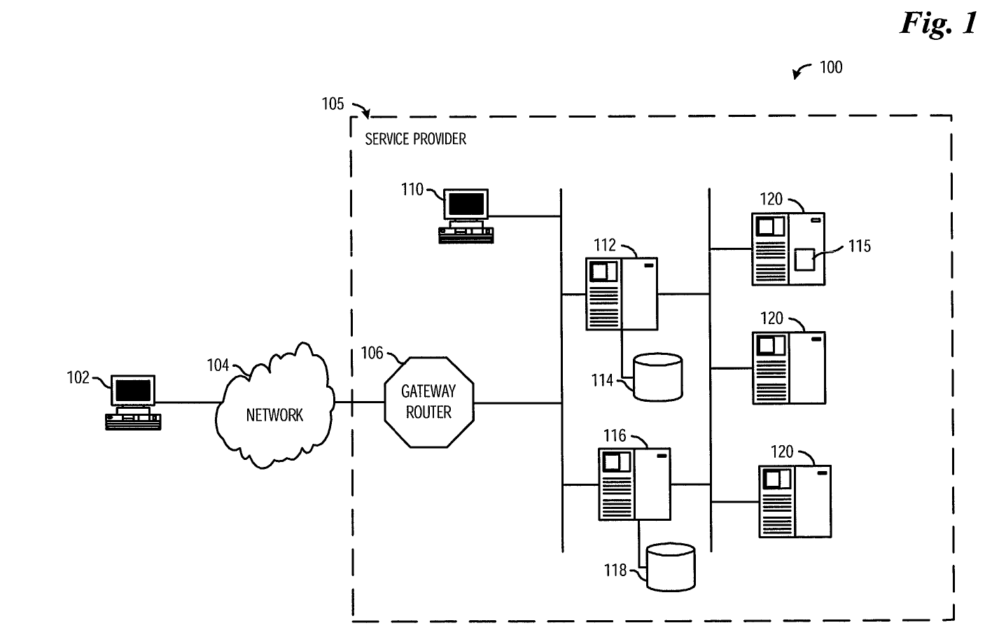

Referring to FIG. 1 of the drawings, the reference numeral 100 generally designates a network environment embodying features of the present invention. The network environment 100 comprises an access device 102, such as a personal computer, Personal Data Assistant (PDA), or the like, coupled to a network 104, such as the Internet or the like. The network 104 is coupled to one or more service providers 105. The service provider 105 generally comprises a gateway router 106 configured for providing access to one or more content hosts 120, 121, and 122 via one or more cache proxies, such as cache proxies 112 and 116, which are preferably coupled to a cache memory 114 and 118, respectively.

One or more of the one or more content hosts 120, 121, and 122 are preferably configured to comprise a cache manager, such as the cache manager 115 of the content host 120, for each Uniform Resource Locator (URL), which designates information contained in the one or more content hosts 120, 121, and 122, and in the response from the one or more content hosts 120, 121, and 122. Additionally, one or more of the cache proxies 112 and 116 are configured to serve a cache manager 115 by caching the responses provided by the content hosts 120 121, and/or 122 that are controlled by the cache manager 115.

A response from the content hosts 120, 121, and 122 generally comprises one or more URLs, the information associated with the one or more URLs (the “URL information”), and control/header information. Furthermore, the cache proxies 112 and 116 are preferably configured to use the URL as the key, or index, to locate and/or store the URL information in the cache.

Additionally, a maintenance device 110 is preferably configured to request updates to information contained in the content hosts 120, 121, and 122 via the cache proxies 112 and/or 116.

Additional network elements, such as a network dispatcher (not shown), may be added to the network environment 100 as required to gain additional efficiencies for the service provider 105. For example, a network dispatcher may be added to partition requests to specific cache proxies and/or content hosts. Other network environments 100 in which the present invention applies will be obvious to one skilled in the art upon a reading of the present disclosure, and, accordingly, is to be included within the scope of the present invention.

Furthermore, the cache manager 115 is shown and disclosed as residing on one or more of the content hosts 120, 121, and/or 122 for exemplary purposes only and may reside on a network 10 component other than the content hosts 120, 121, and/or 122, such as the cache proxies 112 and 116, the network dispatcher (not shown), or the like, or on a stand-alone element. As a result, the cache manager 115 residing on one or more of the content hosts 120, 121, and/or 122 should not be construed as limiting the present invention in any manner.

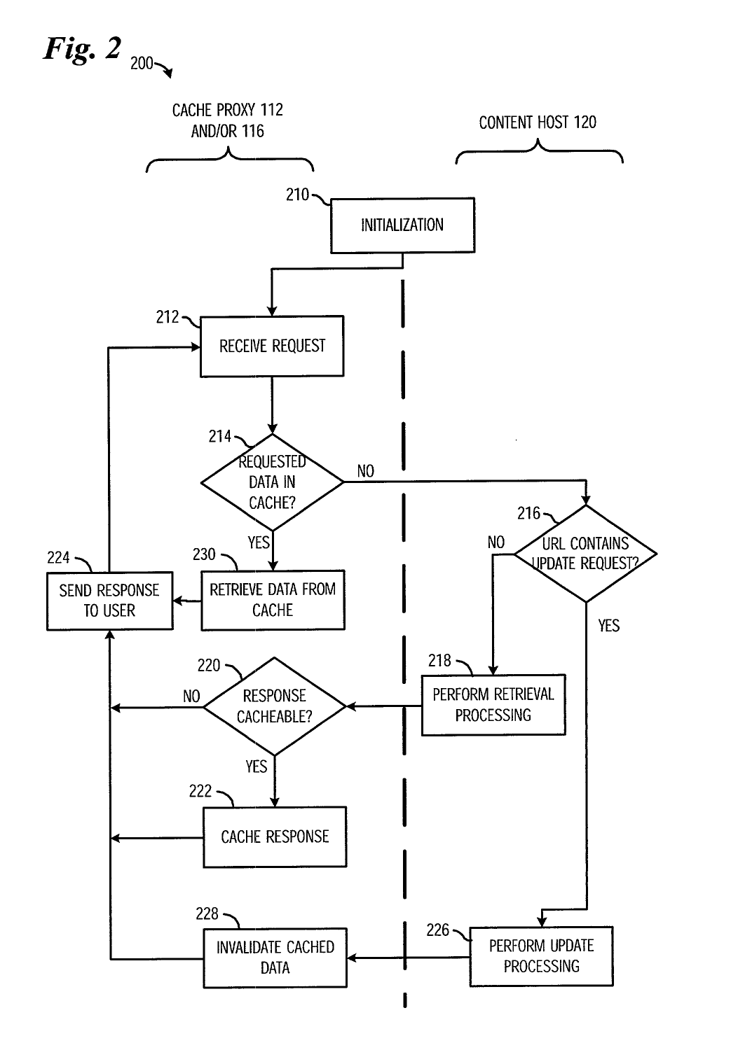

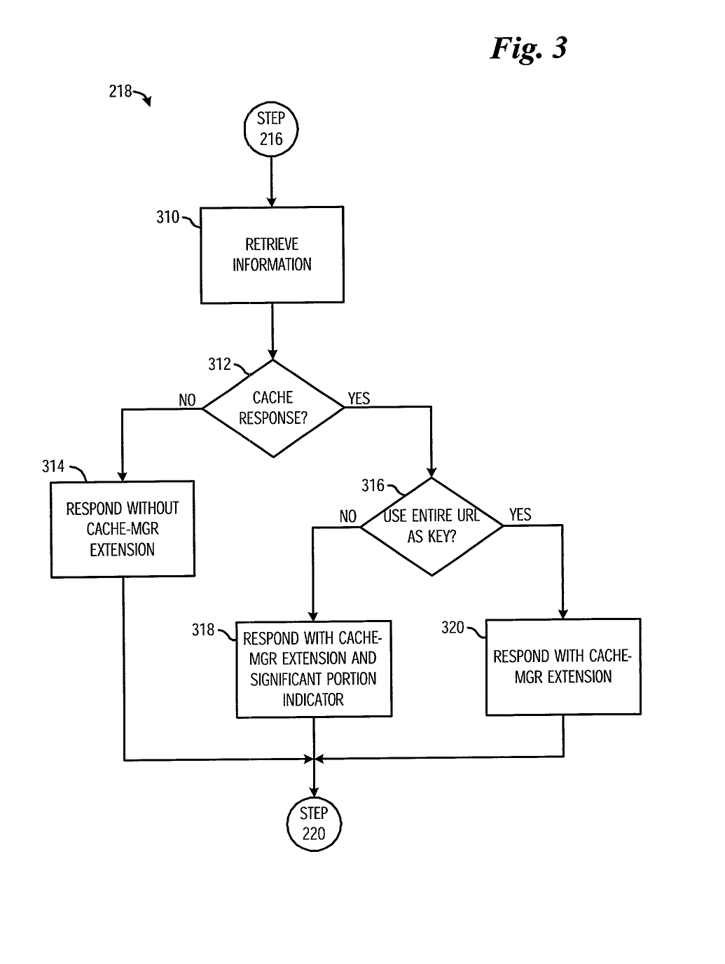

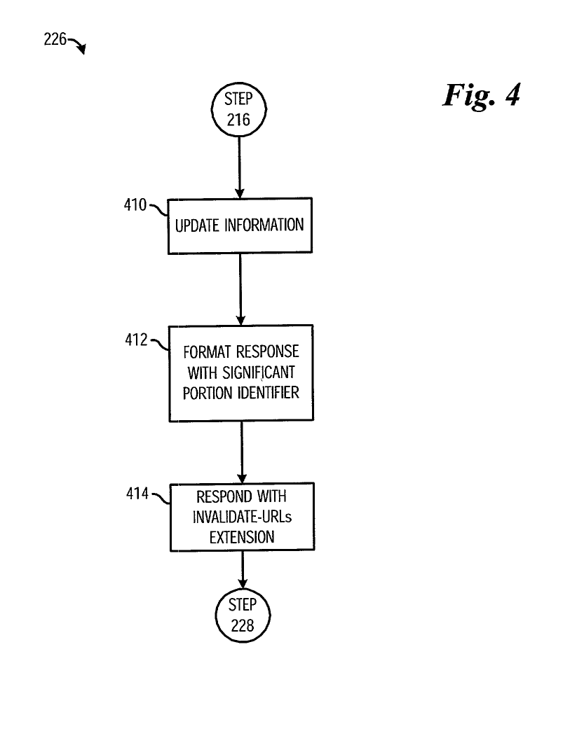

FIGS. 2-4 depict flowcharts 200, 300, and 400, respectively, of steps that may be performed by the cache proxies 112 and/or 116, and/or the content hosts 120 for controlling the caching of URL information retrieved from the content hosts 120. Specifically, the flowchart 200 is a high-level flowchart illustrating the processing performed by the cache proxies 112 and/or 116, and the content hosts 120. FIG. 3 illustrates step 218 (FIG. 2) in greater detail and FIG. 4 illustrates step 226 (FIG. 2) in greater detail.

Referring to FIG. 2, in step 210 the cache proxy 112 and/or the content host 120 perform initialization procedures. Preferably, the cache proxy 112 is identified as a cache for the content host 120 for the relevant URLs, as discussed above, by a statement in the configuration file, such as the ibmproxy.conf file of the IBM WebSphere Edge Server. The following statement comprises an example of a statement that may be used in the configuration file to identify the cache proxy 112 as the cache serving the cache manager 115 of the content host 120:

ExternalCacheManager<cache manager ID><elapsed expiration time>

The “<cache manager ID>” is preferably a unique identifier that identifies the cache manager 115. Optionally, the configuration statement may contain an “<elapsed expiration time>” field that indicates the default elapsed time for which the cached URL information is valid. After the cached URL information has been in the cache for the elapsed expiration time, the URL information is marked invalid and will be retrieved from the content hosts 120, 121, and/or 122 upon receiving another request for the URL. The inclusion of the above statement identifies the cache proxy 112 as the cache for responses in which the cache manager 115 is responsible.

Preferably, the network environment 100 is configured to route requests for a particular URL, such as retrieval requests, update requests, and the like, to a specific cache proxy that is responsible for evaluating requests and responses for that particular URL. Since the network environment generally routes requests to the appropriate cache proxy, the content host 120 will by default respond to the cache proxy 112 responsible for caching responses of the content host 120.

If, however, the network environment 100 is not configured in such a manner, such as routing requests to the first available cache proxy, it is preferable that responses received by a cache proxy be routed to the cache proxy 112 responsible for caching the response of the content host 120 as specified by the ExtemalCacheManager statement discussed above, i. e., responses from the content hosts 120 containing “<cache manager ID>” are preferably routed to the cache proxy 112 identified as the cache proxy for that URL and/or cache manager 115. For example, if the cache proxy 112 was configured with the “<cache manager ID>” IBM-WTE-XYZ-1, then all responses containing the “<cache manager ID>” IBM-WTE-XYZ-1 are preferably routed to the cache proxy 112. The cache proxy 112 caches the URL information contained in the response in the cache 114 for retrieval in response to another request for the URL.

In step 212, a request is received by the cache proxy 112. After receiving the request in step 212, processing continues to step 214, wherein a determination is made whether the requested URL information is in the cache 114. The request may be either an update request to update information, such as a price list, stock quotes, airline arrival times, and the like, on the content hosts 120, or a retrieve request to retrieve information, such as tourist information, company information, research information, and the like, from the content hosts 120. Update requests generally contain URLs that will not be contained in cache because updates are performed on URLs that are different than the URL that is used in retrieving and storing the URL information. As a result, if a request is an update request or is a retrieve request for URL information not contained in the cache 114, then the requested data will not be in the cache 114.

If, in step 214, a determination is made that the requested URL information is not in the cache 114, then processing continues to step 216, wherein a determination is made whether the URL contains an update request. Typically, an update request comprises a URL appended with update instructions and the updated information.

If, in step 216, a determination is made that the request does not contain an update request, then processing continues to step 218, wherein the retrieval processing is performed as described in further detail below with reference to FIG. 3. Upon completion of the retrieval processing performed in step 218, processing proceeds to step 220, wherein a determination is made whether the response from the content host 120 contains URL information that may be cached Preferably, as will be discussed below with reference to FIG. 3, the response contains a directive that indicates whether the URL information is to be cached and, if so, the cache proxy that is to cache the URL information.

If, in step 220, the response indicates that the URL information may be cached, then processing continues to step 222, wherein the URL information is cached by the cache proxy 112 indicated in the response as discussed below with reference to FIG. 3. Thereafter, the processing proceeds to step 224, wherein the response is sent to the user.

If, in step 220, the response indicates that the URL information may not be cached, then processing proceeds to step 224, wherein the response is sent to the user.

If, in step 216, a determination is made that the request contains an update request, then processing proceeds to step 226, wherein the update processing is performed as described in further detail below with reference to FIG. 4. Thereafter, processing proceeds to step 228, wherein the URL information contained in cache, if any, is invalidated, and, in step 224, the response is sent to the user.

If, in step 214, a determination is made that the requested data is in cache, then processing proceeds to step 230, wherein the requested data is retrieved from cache, and, in step 224, the response is sent to the user.

FIG. 3 illustrates a method for performing the retrieval processing discussed above with respect to step 218 (FIG. 2), in accordance with a preferred embodiment of the present invention. Accordingly, if a determination is made in step 216 (FIG. 2) that the request does not contain an update request, processing proceeds to step 218 (FIG. 2), the details of which are depicted by steps 310-20 of FIG. 3. Generally, as will be discussed in greater detail below, the information of the content host 120 is updated and a response is returned comprising an invalidate directive.

Referring now to FIG. 3, in step 310 the retrieve request is received by the content hosts 120 and the URL information is retrieved by the content host 120. After retrieving the information, processing proceeds to step 312, wherein a determination is made whether to allow caching of the URL information. The caching of the URL information is dependent upon the static and/or dynamic nature of the response, security issues, and the like. For instance, if the URL information is highly dynamic and critical, such as a stock price quote, it may be desirable to prevent caching of the information. On the other hand, however, if the URL information is static or not highly dynamic, such as price lists, schedules, and the like, it may be preferable to the developer and system administrator to allow caching.

If, in step 312, a determination is made that the URL information is not to be cached, then processing proceeds to step 314, wherein the content host 120 responds with a response indicating that the URL information is not to be cached. Preferably, to prevent caching, the content host 120 formats a response that comprises a “no-cache” directive to the Cache-Control header field as defined by RFC 2068, which is incorporated herein by reference for all purposes. For example, the following Cache-Control header field could be included in the response to indicate that the URL information contained in the response is not to be cached:

Cache-Control: no-cache

Upon completion of step 314, the processing proceeds to step 220 (FIG. 2), wherein a determination is made whether the response is cacheable.

If, however, in step 312, a determination is made that the URL information is to be cached, then processing preferably proceeds to step 316, wherein a determination is made whether the entire URL is to be used as the key to cache the URL information. Generally, cache proxies, such as cache proxies 112 and 116, cache URL information based on a key, which is preferably the URL. To prevent multiple copies of the same information being cached under differing URL keys, it is desirable that the URL in the response contain a significant portion identifier to indicate the portion of the URL that is to be used as the key for caching purposes, allowing a single copy to be kept that may be easily invalidated. A URL that contains a significant portion identifier is referred to as a partial URL. For example, a user (via the access device 102) may request of a content host 120 information that includes general information that is pertinent to all users, and that includes user-specific information. In this scenario, it is preferred to allow the cache proxy 112 serving the cache manager 115, or some other cache proxy, to use only the significant portion of the URL as a key to cache the general information.

Therefore, if a determination is made in step 316 that the entire URL is not to be used as the key, i.e., only a portion of the URL is to be used as a key to cache the URL information, then processing proceeds to step 318, wherein a response is sent that contains a significant portion indicator and a cache-mgr directive (discussed below with reference to step 320) that indicates the cache manager 115 of the URL.

Preferably, the significant portion identifier, such as a “&.”, is contained in the response to indicate to the cache proxy 112 that only the portion of the URL preceding the “&.” is to be used as the key for caching. Upon completion of step 318, processing proceeds to step 220 (FIG. 2), wherein a determination is made whether the response is cacheable.

Alternatively, the significant portion identifier may be included in all responses, instead of only responses in which a portion of the URL is to be used as a key by the cache proxy 112. Using this alternative, responses in which the entire URL is to be used as the key for the URL by the cache proxy 112, such as for purposes of invalidating the cache, caching the response, and the like, the significant portion identifier is placed at the end of the URL.

If, however, in step 316, a determination is made that the entire URL is to be used as the key, then processing proceeds to step 320, wherein a response is sent comprising a cache-mgr directive, allowing the cache proxy to use the entire URL as a key to cache the URL information.

As stated above, the response generated in steps 318 and 320 preferably comprise a “cache-mgr” cache-extension to the “no-cache” directive of the Cache-Control header. Unlike the “no-cache” directive discussed above with reference to step 312, however, including the “cache-mgr” cache-extension informs recipients of the response that the response is to be cached only by the cache proxy 112 serving the cache manager 115, thereby limiting the caching of the URL information.

For example, a response from the content host 120, such as the response generated in steps 318 and/or 320, to an update request to update the pricing information may contain the following Cache-Control cache-response-directive to indicate that only the cache proxy serving the cache manager 115 is to cache the response:

Cache-Control: no cache, cache-mgr=<cache manager ID>

As discussed above, the “no-cache” directive generally indicates that the URL information contained in a response containing the “no-cache” directive is not to be cached by any component, such as the cache proxy 112, receiving the response. The “cache-mgr=<cache manager ID>” extension, however, indicates that the URL information is only to be cached by the cache proxy serving the cache manager identified by “cache-mgr=<cache manager ID>” string, wherein <cache manager ID> is as discussed above with reference to step 210 (FIG. 2). By doing so, the service provider 105 is able to control the caching of the URL information and, therefore, is able to invalidate the cached URL information at a future time.

Upon completion of step 320, processing proceeds to step 226 (FIG. 2), wherein a determination is made whether the response is cacheable.

FIG. 4 illustrates a method for performing the update processing discussed above with respect to step 226 (FIG. 2), in accordance with a preferred embodiment of the present invention. Accordingly, if a determination is made in step 216 (FIG. 2) that the request is an update request, processing proceeds to step 226 (FIG. 2), the details of which are depicted by steps 410-14 of FIG. 4. Generally, as will be discussed in greater detail below, the information of the content host 120 is updated and a response is returned comprising an invalidate directive.

Referring now to FIG. 4, in step 410 the update request is processed by updating the information contained on the content host 120 with the information contained in the update request. After updating the information in step 410, processing proceeds to step 412, wherein, optionally, a response is formatted that comprises one or more URLs that include a significant portion identifier as discussed with reference to step 316 (FIG. 3).

Thereafter, processing proceeds to step 414, wherein a response is returned comprising an invalidate extension. Preferably, the “invalidate-urls” extension is sent as a cache-extension to the Cache-Control cache-response-directive of “no-cache” as defined by the RFC 2068, and provides the cache proxy 112 with a list of one or more URLs that are to be invalidated.

For example, a response from the content host 120 to an update request to update pricing information may contain the following Cache-Control cache-response-directive to indicate to the cache proxy 112 that one or more cached URLs are no longer valid:

Cache-Control: no cache, cache-mgr=<cache manager ID>,

invalidate-urls=<one or more urls>

The “no-cache” directive generally indicates that the response in which the “no-cache” directive is attached is not to be cached by any component, such as the cache proxy 112, receiving the response. Additionally, the “invalidate-urls” extension provides a list of one or more URLs, as indicated by the “<one or more urls>” field, that are to be invalidated.

By way of example, consider the following retrieve request received by the content host 120:

/tpcw?00=03&41=813&.

The “tpcw” represents the requested URL. The “&.” is the optional significant portion identifier that indicates the end of the portion of the request that is to be used as the key for caching purposes of the URL information.

The response to the above request preferably comprises the requested information with the following Cache-Control header field:

Cache-Control: no-cache,cache-mgr=abcd

The inclusion of the “no-cache” directive and the “cache-mgr” extension prevents caching of the response by any component other than the cache proxy responsible for serving the cache manager “abcd,” i.e., cache proxy 112.

If, however, the request is an update request, such as the following request:

/tpcw?00=24&41=813&04=288.45&08=813&09=813&.

then the response preferably comprises an “invalidate-urls” extension to the “no-cache” directive. An example of the Cache-Control header comprising an “invalidate-urls” extension to the “no-cache” directive is as follows:

Cache-Control: no-cache,cache-mgr=abcd, invalidate-urls=/tpcw?00=16&41=813&.

/tpcw?00=17&41=813&. /tpcw?00=03&41=813&.

In the above Cache-Control header, the URL information (not shown) associated with the three URLs, namely, “?00=16&41=813,” “?00=17&41=813,” and “00=03&41=813,” will be invalidated by the cache proxy 112 serving the cache manager 115 identified by the “abcd” field.

Additionally, the significant portion identifier may be used in a response to specify the key that should be used by the cache proxy 112 for caching purposes. For instance, in the following response, the cache proxy serving the cache manager “abcd,” such as cache proxy 112, caches the URL by the key, i.e., the URL, only to the first significant portion identifier, namely, “/tpcw?00=07&41=813&04=288.45&08=813&09=813&.”

/tpcw?00=07&41=813&04=288.45&08=813&09=813&..x=60&..y=16

In other words, the cache proxy 112 preferably treats the above response equivalent to the following responses:

/tpcw?00=07&41=813&04=288.45&08=813&09=813&.

/tpcw?00=07&41=813&04=288.45&08=813&09=813

/tpcw?00=07&41=813&04=288.45&08=813&09=813&..x=60

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

1. A method to control caching of URL information included in a response, the method comprising the steps of:
indicating in the response which of one or more cache proxies is to cache the URL information; and
transmitting the response to the one or more cache proxies of the URL information.

2. The method of claim 1, wherein the response includes a URL comprising a significant portion identifier that specifies the portion of the URL that is to be used as a key for the URL information.

3. A method to control caching of URL information included in a response, the method comprising the steps of:
indicating in the response that the URL information is to be invalidated; and
transmitting the response to one or more cache proxies of the URL.

4. The method of claim 3, wherein the response includes a URL comprising a significant portion identifier that specifies the portion of the URL that is to be used as a key for the URL information.

5. A method of managing a cache of a response having a URL, URL information associated with the URL, and a header, the method comprising the steps of:
identifying a cache proxy as serving a cache manager of the URL; and
indicating in the header whether the URL information is to be cached, is not to be cached, is to be cached by the cache proxy serving the cache manager, or is to be invalidated by the one or more cache proxies.

6. The method of claim 5, wherein the URL is a partial URL, wherein the partial URL comprises a significant portion identifier that specifies the portion of the URL that is to be used as a key.

7. A method to control caching of URL information associated with one or more URLs of a response, the method comprising the steps of:
identifying a cache proxy as serving a cache manager for one or more URLs;
receiving by a first cache proxy the response comprising a header and the one or more URLs, the header comprising an indication of whether the URL information is to be cached, invalidated, or only cached by the cache proxy serving the cache manager;
in response to receiving a header comprising an indication that the URL information is to be cached, storing the URL information in the cache;
in response to receiving a header comprising an indication that the URL information is to be cached only by the cache proxy serving the cache manager, determining whether the first cache proxy is the cache proxy serving the cache manager;
in response to determining the first cache proxy is the cache proxy serving the cache manager, storing the URL information in the cache;
in response to determining the first cache proxy is not the cache proxy serving the cache manager, sending the response to the cache proxy serving the cache manager; and
in response to receiving a header comprising an indication that the URL information is to be invalidated, preventing the use of the URL information in cache in response to a second request.

8. The method of claim 7, wherein the one or more URLs comprise one or more partial URLs, and wherein the one or more partial URLs comprises a significant portion identifier identifying the portion of the one or more URLs that is to be used as a key.

9. A method to control caching of URL information associated with one or more URLs of a response, the method comprising the steps of:
entifying a cache proxy as serving a cache manager for the one or more URLs;
receiving by a first cache proxy the response comprising a header, the one or more URLs, and the URL information, the header comprising an indication of whether URL information is to be cached only by the cache proxy serving the cache manager;
determining whether the first cache proxy is the cache proxy serving the cache manager;
in response to determining that the first cache proxy is the cache proxy serving the cache manager, storing the URL information in the cache; and
in response to determining that the first cache proxy is not the cache proxy serving the cache manager, sending the response to the cache proxy serving the cache manager.

10. The method of claim 9, wherein the one or more URLs comprise one or more partial URLs, and wherein the one or more partial URLs comprise a significant portion identifier identifying the portion of the one or more URLs that is to be used as a key.

11. A method to control caching of URL information associated to one or more URLs of a response, the method comprising the steps of:
receiving the response comprising a header, the one or more URLs, and the URL information, the header having an indication of whether the URL information is to be invalidated; and
in response to receiving a header having an indication that the one or more URLs are to be invalidated, preventing the use of the cached URL information in response to a second request.

12. The method of claim 11, wherein the one or more URLs comprise one or more partial URLs, and wherein the one or more partial URLs comprises a significant portion identifier identifying the portion of the one or more URLs that is to be used as a key.

13. An apparatus adapted to control caching of URL information included in a response, the apparatus comprising:
means for indicating in the response which of one or more cache proxies is to cache the URL information; and
means for transmitting the response to the one or more cache proxies.

14. The apparatus of claim 13, wherein the response includes a URL comprising a significant portion identifier that specifies the portion of the URL that is to be used as a key for the URL information.

15. An apparatus adapted to control caching of URL information included in a response, the apparatus comprising:
means for indicating in the response that the URL information is to be invalidated; and
means for transmitting the response to one or more cache proxies.

16. The apparatus of claim 15, wherein the response includes a URL comprising a significant portion identifier that specifies the portion of the URL that is to be used as a key for the URL information.

17. An apparatus adapted to manage a cache of a response having a URL, URL information associated with the URL, and a header, the apparatus comprising:
means for identifying a cache proxy as serving a cache manager for the URL; and
means for indicating in the header whether the URL information is to be cached, is not to be cached, is to be cached by the cache proxy serving the cache manager, or is to be invalidated by the cache proxy.

18. The apparatus of claim 17, wherein the URL is a partial URL, wherein the partial URL comprises a significant portion identifier that specifies the portion of the URL that is to be used as a key.

19. An apparatus adapted to control caching of URL information associated with one or more URLs of a response, the apparatus comprising:
means for identifying a cache proxy as serving a cache manager for the one or more URLs;
means for receiving by a first cache proxy the response comprising a header and the one or more URLs, the header having an indication of whether the URL information is to be cached, invalidated, or cached by the cache proxy serving the cache manager;
in response to receiving a header comprising an indication that the URL information is to be cached, means for storing the URL information in the cache;
in response to receiving a header comprising an indication that the URL information is to be cached by the cache proxy serving the cache manager, means for determining whether the first cache proxy is the cache proxy serving the cache manager;
in response to determining the first cache proxy is the cache proxy serving the cache manager, means for storing the URL information in the cache;
in response to determining the first cache proxy is not the cache proxy serving the cache manager, means for sending the response to the cache proxy serving the cache manager; and
in response to receiving a header comprising an indication that the URL information is to be invalidated, means for preventing the use of the URL information in cache in response to a second request.

20. The apparatus of claim 19, wherein the one or more URLs comprise one or more partial URLs, and wherein the one or more partial URLs comprises a significant portion identifier identifying the portion of the one or more URLs that is to be used as a key.

21. An apparatus adapted to control caching of URL information associated with one or more URLs of a response, the apparatus comprising:
means for identifying a cache proxy as serving a cache manager for the one or more URLs;
means for receiving by a first cache proxy the response comprising a header, the one or more URLs, and the URL information, the header having an indication of whether URL information is to be cached only by the cache proxy serving the cache manager;
in response to receiving a header comprising an indication that the URL information is to be cached by the cache proxy serving the cache manager, means for determining whether the first cache proxy is the cache proxy serving the cache manager;
in response to determining the first cache proxy is the cache proxy serving the cache manager, means for storing the URL information in the cache; and
in response to determining the first cache proxy is not the cache proxy serving the cache manager, means for sending the response to the cache manager.

22. The apparatus of claim 22, wherein the one or more URLs comprise one or more partial URLs, and wherein the one or more partial URLs comprises a significant portion identifier identifying the portion of the one or more URLs that is to be used as a key.

23. An apparatus adapted to control caching of URL information associated to one or more URLs of a response, the apparatus comprising:
means for receiving the response comprising a header, the one or more URLs, and the URL information, the header comprising an indication of whether the URL information is to be invalidated; and
in response to receiving a header comprising an indication that the one or more URLs are to be invalidated, means for preventing the use of the cached URL information in response to a second request.

24. The apparatus of claim 23, wherein the one or more URLs comprise one or more partial URLs, and wherein the one or more partial URLs comprises a significant portion identifier identifying the portion of the one or more URLs that is to be used as a key.
